(19) United States
(12) Patent Application Publication
(10) Pub. No.: US 2020/0164716 A1
(43) Pub. Date: May 28, 2020

(54) Method And Mobile Terminal For Controlling At Least One Air-Conditioning Device

(71) Applicant: Webasto SE, Stockdorf (DE)

(72) Inventors: GÜNTHER FELLNER, Stockdorf (DE); DANIEL THÜRMER, Stockdorf (DE)

(21) Appl. No.: 16/611,631

(22) PCT Filed: May 4, 2018
(86) PCT No.: PCT/EP2018/061531

§ 371 Date: Nov. 7, 2019

(30) Foreign Application Priority Data
May 8, 2017 (DE) 10 2017 109 860.7

(51) Int. Cl. B60H 1/00; G08C 17/02; H04W 72/04

(52) U.S. Cl. CPC B60H 1/00657; B60H 1/00007; H04W 4/80; H04W 72/0453; G08C 17/02

(57) ABSTRACT

A method for controlling at least one air-conditioning device of a vehicle includes the steps of:
querying first status data from a first bus, preferably an air-conditioning bus, which is connected to the at least one air-conditioning device, via a radio interface;
querying second status data from a second bus, in particular a vehicle, which is connected to at least one actuator and/or sensor, via the radio interface;
displaying the first and second status data on a display;
receiving at least one user input;
processing the user input;
creating a control command on the basis of the user input and using at least one data element of the first and/or second status data;
transmitting the control command to the air-conditioning device via the radio interface.

### CROSS-REFERENCE TO RELATED APPLICATIONS

This application represents the national stage entry of PCT International Patent Application No. PCT/EP2018/061531 filed on May 4, 2018 and claims priority to German Patent Application No. DE 10 2017 111 373.8 filed May 24, 2017, German Patent Application No. DE 10 2017 109 860.7 filed May 8, 2017. The contents of each of these applications are hereby incorporated by reference as if set forth in their entirety herein.

### DESCRIPTION

The disclosure relates to a method and a mobile terminal for controlling at least one air-conditioning device and to a system and a computer-readable storage medium for implementing the method.

Modern vehicles can be equipped with different air-conditioning devices, for example heaters, fans and cooling units. Furthermore, it is known practice to subsequently equip vehicles with appropriate air-conditioning devices. It is thus possible to subsequently install an air-conditioning device, for example an auxiliary heating system, in a vehicle.

Appropriate air-conditioning devices sometimes have communication devices for wirelessly communicating with an operating unit. It is therefore known practice to provide small remote controllers which, with a range of approximately 200 to 1000 metres, make it possible to start and possibly also stop the operation of an auxiliary heating system.

There are also possible ways of controlling the air-conditioning devices by means of mobile terminals, for example smartphones and tablets. These communicate with the air-conditioning device via a cellular network, for example GSM, and model a similar function to that offered by the remote controllers already described.

The control possibilities offered by corresponding systems are greatly limited. It may happen that a control command is not executed, for example on account of an excessively low state of charge of the battery, without the user becoming aware of this.

Proceeding from this prior art, the object of the present disclosure is to specify an improved method for controlling at least one air-conditioning device. In particular, existing disadvantages from the prior art are intended to be eliminated. The disclosure is intended to make it possible to operate the air-conditioning device in a safe, economical and reliable manner. Furthermore, the intention is to specify a mobile terminal for controlling the at least one air-conditioning device and a system for implementing the method.

In terms of the method, this object is achieved by means of a method according to claim 1.

In particular, the object is achieved by means of a method for controlling at least one air-conditioning device of a vehicle, wherein the method comprises the following steps of:
querying first status data from a first bus, preferably an air-conditioning bus, which is connected to the at least one air-conditioning device, via a radio interface;
querying second status data from a second bus, in particular a vehicle bus, which is connected to at least one actuator and/or sensor, via the radio interface;
displaying the first and second status data on a display;
receiving at least one user input;
processing the user input;
creating a control command on the basis of the user input and using at least one data element of the first and/or second status data;
transmitting the control command to the air-conditioning device via the radio interface.

A concept of the present disclosure involves querying and displaying status data, which describe the state of at least one component in the vehicle, before creating a control command. For this purpose, status data are advantageously tapped off from a first bus, which is connected at least to the at least one air-conditioning device, and status data are tapped off from a further, second bus, for example a vehicle bus. The second bus may be connected to one or more actuators and/or sensors. The second bus preferably provides information relating to vehicle components, for example the battery, the vehicle tank, and/or general information relating to the state of the vehicle, for example the operating state of the vehicle.

Using the disclosure, it is therefore possible for the user to capture the state of the vehicle and of the air-conditioning device before transmitting a control command and to emit particular control commands in response to this. In one embodiment, the control command is generated on the basis of a user input and at least one data element of the first status data. For example, it is possible to query whether the air-conditioning device is fundamentally in a state ready for operation. Depending on the knowledge obtained, the method according to the disclosure can allow or prohibit the transmission of a control command for starting the air-conditioning device. Accordingly, depending on whether or not the air-conditioning device is already running, a user command can be interpreted differently. For example, the input of a user command requesting a power increase can result, in the switched-off state, in a control command which starts the air-conditioning device first of all being transmitted and a further control command which adapts the power of the air-conditioning device according to the input then being transmitted. If the air-conditioning device has already been started in the described embodiment, the user input can be interpreted such that only the power is adapted in a corresponding manner.

The disclosure makes it possible to capture and display various items of information relating to the vehicle and the air-conditioning device. Furthermore, this information can be used “intelligently” when carrying out the control method in order to make it possible to control the air-conditioning device as efficiently as possible. Software or an app implementing the method can thus use a graphical user interface which makes it possible to operate the air-conditioning device in a substantially more efficient manner. This prevents incorrect operation. The method can be adaptive or can be implemented on an adaptive system which makes it easier for the user to operate the air-conditioning device. It is possible to use algorithms and/or data structures which are known from the development in the field of “artificial intelligence”.

In one embodiment, a value is calculated on the basis of at least one data element of the first status data and at least one data element of the second status data and is displayed. The teaching according to the disclosure makes it possible to query different items of information and to connect them to one another. For example, a power consumption of the air-conditioning device can be queried and can be compared with information relating to the state of charge of a battery. As a result, the user of the control method can be supplied with information which makes it possible for the user to estimate an operating period. In this respect, the method can also be used to prevent incorrect operation in which the battery is completely discharged, for example.

In one embodiment, at least some status data are indirectly queried via a gateway device.

It is possible to implement communication with the first bus and the second bus in different ways. In one preferred embodiment, use is made of a gateway device which is connected both to the first bus and to the second bus. The gateway device preferably has at least one communication device for wireless communication. The gateway device can additionally perform control tasks and can control the air-conditioning device according to the received control commands. Providing a gateway device has the advantage that relevant information is collected at a central point. Furthermore, the gateway device can offer standardized wireless communication, with the result that said communication can be easily implemented using the gateway device irrespective of the vehicle types. The gateway device may have accordingly specific interfaces for communicating with vehicle components, for example on the second bus. In one embodiment, the gateway device has an interface which can be programmed to communicate with different bus systems.

In one embodiment, the method additionally comprises the following steps of:
checking the availability of a number of communication channels to a gateway device of the vehicle;
selecting a communication channel on the basis of the availability and a priority list, wherein the first and/or second status data are queried, as described, via the selected communication channel.

According to the disclosure, it is possible, for example, to equip the gateway device with a plurality of different possibilities for wireless communication. In this respect, communication devices which enable WiFi communication, GSM communication and/or Bluetooth communication are conceivable, for example. In one embodiment of the disclosure, an associated terminal may have corresponding communication devices, with the result that different communication channels need to be checked before communication with the gateway device. The method according to the disclosure then selects an available communication channel. If a plurality of communication channels are available, a preferred communication channel, for example a communication channel which does not generate any costs, can be selected and used.

In one embodiment, the method (additionally) comprises the following steps of:
reading a user profile from a storage device of a mobile terminal;
processing data from the user profile;
generating at least one control command on the basis of the data from the user profile;
transmitting the control command to the air-conditioning device and/or a component of the vehicle, preferably using a/the gateway device.

The method according to the disclosure can therefore be used to make adjustments to the air-conditioning device and/or other vehicle components in a user-specific manner. For this purpose, a corresponding user profile can be created in a storage device of a mobile terminal. This user profile may contain, for example, information relating to a particular flap position, which information is selected in such a manner that the user in the vehicle does not have air blown at him directly after activating the air-conditioning device. The method according to the disclosure uses the data assigned to the user to generate control commands which ultimately result in a vehicle configuration which is advantageous for the user. In one embodiment, it is conceivable, in the case of a vehicle which is used by different persons, to store a configuration when a person exits the vehicle and to restore this configuration, for example after use by another person, when the person enters the vehicle again.

In one embodiment, a state of charge of a battery of the vehicle and/or a tank filling state is/are queried. According to the disclosure, the states can be displayed and/or processed as status data. As already explained, the state of charge and/or the information relating to the fuel level make(s) it possible to make statements on how long a particular air-conditioning device can be operated in a particular operating mode. It is likewise possible to select a particular area to be heated on the basis of the state of charge of a battery. There are thus vehicles in which a plurality of cooling circuits, for example for cooling/heating the engine compartment and for cooling/heating the passenger compartment, are provided. Depending on the state of charge of the battery, the method according to the disclosure can desist from heating the engine compartment and can therefore accordingly adapt the control commands.

The object mentioned at the outset is also achieved by means of a mobile terminal comprising at least one computing device, at least one storage device and at least one radio communication device. The storage device preferably has instructions for implementing the method steps already described. The radio communication device can be used to query the first and/or second status data. Furthermore, the communication device can be used to transmit the at least one control command.

The advantages explained in connection with the methods also arise in connection with the mobile terminal.

The object mentioned at the outset is also achieved by means of a system. The system may comprise a mobile terminal, as explained above, and a gateway device. The gateway device may comprise a communication device for wireless communication, wherein the communication device is designed to communicate with the mobile terminal, in particular by means of Bluetooth. The communication device may be able to be plugged in, with the result that the gateway device can be subsequently upgraded.

In one embodiment, the gateway device has a plurality of communication devices, for example a first communication device and a second communication device. The first communication device may be designed to wirelessly communicate with the mobile terminal via Bluetooth and/or WiFi. The second communication device may wirelessly communicate with the mobile terminal via a cellular network, for example via the GSM or UMTS standard.

In the corresponding system, it is possible to choose between different communication channels, with the result that reliable communication is always ensured on the basis of the distance between the mobile terminal and the gateway device.

In one embodiment, the gateway device is designed to communicate as the master on the air-conditioning bus and comprises a control device for controlling the air-conditioning device.

In one embodiment, the air-conditioning device and/or the operating element may each be in the form of a slave of the air-conditioning bus.

In one embodiment, the air-conditioning device may be in the form of a blower and/or a fan. It is therefore also possible for only a blower to be operated using the gateway device. Hardware of a vehicle which has already been installed can therefore also be controlled via the gateway device.

In one embodiment, the communication device can be able to be plugged in, for example in the form of a printed circuit board, wherein the communication device may be designed to communicate with a/the mobile terminal, in particular by means of Bluetooth.

According to the disclosure, the gateway device has the possibility of wirelessly receiving and transmitting data via a communication device. The air-conditioning bus and the devices connected to the latter are therefore accessible to devices which are outside the vehicle or outside the vehicle hardware.

The gateway device may comprise:
at least one computing device;
at least one storage device containing instructions, wherein the instructions implement a web server when they are executed on the computing unit.

The algorithms implemented on the web server may be adaptive and may make it easier for the user to operate the air-conditioning device. It is possible to use algorithms and/or data structures which are known from the development in the field of “artificial intelligence”.

The object mentioned at the outset is also achieved by means of a computer-readable storage medium containing instructions which cause at least one processor to implement a method as already described above.

Further advantageous embodiments emerge from the subclaims.

The disclosure is described below on the basis of a plurality of exemplary embodiments which are explained in more detail by means of figures, in which:

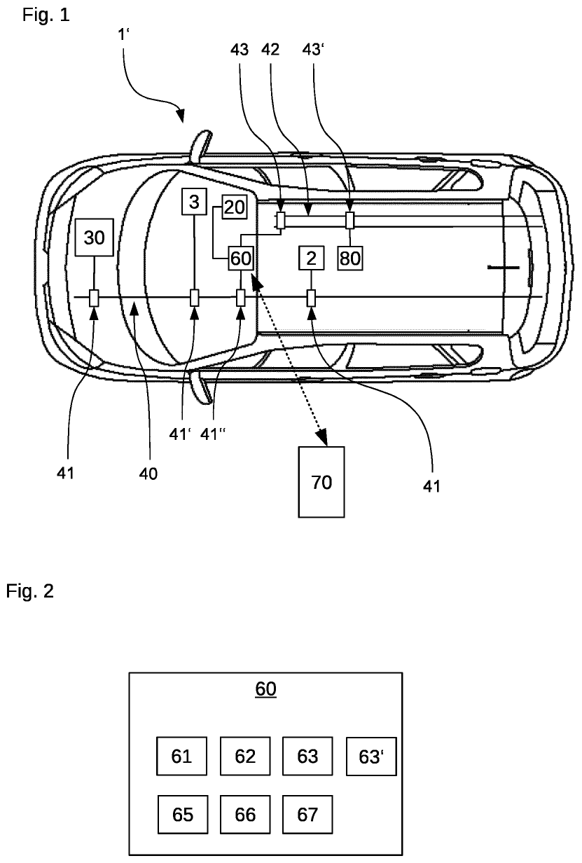

FIG. 1 shows a schematic view of a vehicle having an air-conditioning bus, wherein some components, comprising an air-conditioning device, are connected to the air-conditioning bus;

FIG. 2 shows a schematic view of a gateway device for use in a vehicle according to FIG. 1;

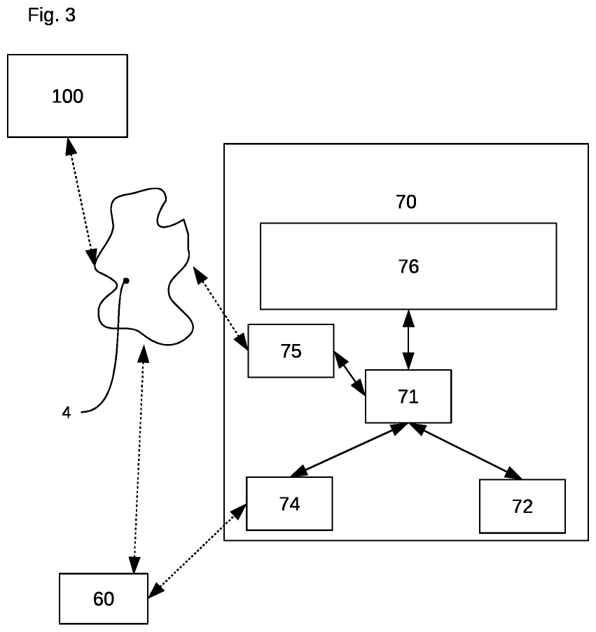

FIG. 3 shows a schematic view of a mobile terminal which wirelessly communicates with the gateway device from FIG. 2.

In the following description, the same reference numerals are used for identical and identically acting parts.

FIG. 1 shows a vehicle 1 and a mobile terminal 70. The vehicle 1 is illustrated with the components which are important for understanding the disclosure. The vehicle 1 thus has a heater 30, a gateway device 60, an operating element 2, a ventilation device 20 and a fan flap 3. The heater 30, the gateway device 60 and the operating element 2 are connected to the air-conditioning bus 40 via connections 41, 41′, 41″ and are connected to one another via the air-conditioning bus 40. In the exemplary embodiment shown, the air-conditioning bus 40 is in the form of a proprietary W bus.

The W bus is distinguished by the fact that a master controls the communication between a multiplicity of slaves and with the master. The master can therefore initiate communication without agreement with other components. The air-conditioning bus 40 shown in FIG. 1 has a wire which is terminated at its end by means of a pull-up resistor.

In the exemplary embodiment shown, the gateway device 60 is in the form of the master of the air-conditioning bus 40 and uses a bus communication device 63 for communication. The heater 30, the fan flap 3 and the operating element 2 are in the form of slaves. This means that the gateway device 60 can transmit data to the heater 30, the fan flap 3 and the operating element 2 without being requested to do so. Those components which act as a slave on the air-conditioning bus 40 must initially ask the gateway device 60 whether they are allowed to communicate on the air-conditioning bus 40.

In the exemplary embodiment in FIG. 1, the operating part 2 is in the form of an input/output device. The driver of the vehicle 1 can use the operating part 2 to input a desired temperature as a target parameter in the interior of the vehicle 1. The operating part 2 then transmits the desired temperature as the target parameter to the gateway device 60 on the air-conditioning bus 40 via the connection 41. The gateway device 60 comprises a temperature sensor 67 which measures the temperature in the interior of the vehicle 1. If the desired temperature set by the driver does not correspond to the measured temperature value in the interior of the vehicle 1, the gateway device 60 transmits a control command to the heater 30 via the air-conditioning bus 40. If the gateway device 60 has determined that the temperature in the interior of the vehicle 1 is too low, the heater 30 is prompted to perform heating. The heater 30 heats the vehicle interior until the gateway device 60 measures, by means of its temperature sensor 67, that the desired temperature input by the driver has been reached.

In order to make it possible to efficiently heat the vehicle interior of the vehicle 1, the gateway device 60 additionally transmits control commands to the fan flap 3. The fan flap 3 comprises an actuator, for example a servomotor or a stepper motor which is designed to change an adjustment angle of the fan flap 3. In the exemplary embodiment shown, the fan flap 3 is adjusted in such a manner that an air flow which is as large as possible can flow through it, for example is adjusted to 90°.

So that the heated air can flow through the fan flap 3, the gateway device 60 also transmits a pulse width modulation signal (PWM signal) to the ventilation device 20. For this purpose, the gateway device 60 has a PWM controller, for example a microcontroller, which outputs a corresponding signal via a ventilation connection 21 which connects the gateway device 60 to the ventilation device 20. The ventilation device 20 has a motor which is driven by the PWM signal.

The gateway device 60 also comprises a Bluetooth module 62 (see FIG. 2) which can be used to wirelessly communicate with a device in the vicinity. For example, it is possible to establish a Bluetooth connection to a mobile terminal 70. The mobile terminal 70, which is a smartphone belonging to the driver for example, can also be used to set a desired temperature in the interior of the vehicle 1. After a desired temperature value has been input, the smartphone 70 transmits a control command to the gateway device 60 via the Bluetooth connection. The gateway device 60 forwards the control command to the heater 30 and generates, on the basis of the received control command, further control commands (for example specific to the air-conditioning bus) which are transmitted to the air-conditioning device 30 via the air-conditioning bus 40. The heater 30 is therefore controlled in such a manner that the temperature in the vehicle interior corresponds to the desired temperature value.

In addition, the gateway device 60 can transmit status information, in particular status data, relating to the devices connected to the air-conditioning bus 40 to the mobile terminal 70. For example, the status information may be maintenance advice, sensor data, manufacturer information or fault messages. Status data which relate to the air-conditioning bus 40 preferably indicate an operating state of the heater 30 (ON or OFF) and an operating power (for example 70% of the maximum power). The driver of the vehicle 1 therefore has access to all information relating to the devices connected to the air-conditioning bus 40.

In addition to the air-conditioning bus 40, the vehicle 1 has a vehicle bus 42. The gateway device 60 is connected to the vehicle bus 42 via a bus communication device 63′ and an air-conditioning operating part 80 is connected to the vehicle bus 42. The gateway device 60 is in the form of a slave of the vehicle bus 42. The gateway device 60 therefore assumes a dual function. On the one hand, it acts as the master on the air-conditioning bus 40 and, on the other hand, it acts as a slave on the vehicle bus 42. In one embodiment according to the disclosure, the gateway device 60 has only a monitoring/reading function with respect to the vehicle bus 42 and only listens in to the data traffic on the vehicle bus 42. In the exemplary embodiment illustrated in FIG. 2, the air-conditioning operating part 80 is used to accept a user input and to provide it as status information, in particular vehicle data, to the gateway device 60 via the vehicle bus 42.

According to the disclosure, the Bluetooth communication device 62 is used to communicate vehicle data, which are received via the vehicle bus 42, to the mobile terminal 70. Such vehicle data may comprise data elements comprising information relating to the filling level of the tank of the vehicle 1 and the battery filling level of the vehicle 1.

In addition to the Bluetooth communication device 62, the gateway device 60 comprises a plug-in LTE module 68 for communication in an LTE network. In the exemplary embodiment, there are therefore a plurality of possibilities (communication channels), via which the mobile terminal 70 can communicate with the gateway device 60. For communication with the gateway device 60, it is not necessary for the smartphone 70 to be in the vicinity of the vehicle 1. It is therefore possible for a driver of the vehicle 1 to control the components of the vehicle 1 from any desired location in the world via the gateway device 60 and/or to receive status data from these components, which data are possibly taken into account during control. On account of this function, the driver can use the mobile terminal 70 to query information transmitted on the air-conditioning bus 40 or on the vehicle bus 42 via the gateway device 60. Comprehensive information relating to the state of the vehicle 1 can therefore be displayed to the driver. According to the disclosure, this information is used to offer services to the terminal 70, which services make it possible to control the air-conditioning system of the vehicle 1 in a very convenient and efficient manner.

FIG. 2 shows a schematic illustration of the gateway device 60. The gateway device 60 comprises a computing unit 61 which is in the form of a microcontroller, for example. The computing device 61 is designed to receive status data via the bus communication devices 63, 63′ and to then process said data. The gateway device 60 also has a Bluetooth module 62 for wirelessly communicating with the terminal 70. In one exemplary embodiment, a further communication device for communicating with a cellular and/or a local area network is provided.

The bus communication devices 63, 63′ are designed to receive and transmit data via the air-conditioning bus 40 and the vehicle bus 42, respectively. Received data can be stored in a storage device 65, with the result that the computing unit 61 can process said data.

In one exemplary embodiment, only the gateway device 60 can be retrofitted. In this case, it is possible to dispense with the installation of additional air-conditioning devices 30 or operating elements 2. It is possible, for example, for an existing air-conditioning system of a vehicle 1 to be monitored and/or controlled by means of the gateway device 60. That is to say, after installation, the user or driver of the vehicle 1 can access the information directly and indirectly related to the air-conditioning system via the mobile terminal 70. In one exemplary embodiment, the gateway device 60 according to the disclosure also makes it possible to query status data which are only remotely related or are not related at all to the air-conditioning device 30 or the air-conditioning system.

FIG. 3 shows, in a highly schematic manner, a mobile terminal 70 which has been individualized according to the disclosure and is communicatively connected to the Internet 4 and to the gateway device 60. According to the disclosure, it is therefore possible for a plurality of communication paths, namely a first communication path directly via Bluetooth and a second communication path indirectly via the Internet, to be available for communicating with the gateway device 60.

In a similar manner to the gateway device 60, the mobile terminal 70 comprises a computing device 71 and a storage device 72 which has instructions for implementing the method according to the disclosure. When these instructions are executed on the computing unit 71, they cause the latter to implement the method according to the disclosure.

A touchscreen 76 which makes it possible to input and output data is provided for the purpose of communicating with the driver. In particular, user inputs can be received and status data which have been queried from the gateway device 60, for example, can be displayed via the touchscreen 76. For communicating with the gateway device 60, the mobile terminal 70 comprises a Bluetooth module 74 and a UMTS module 75 which, as schematically indicated, establishes the connection to the Internet 4. According to the disclosure, the connection to the Internet 4 can also be used to query information from a server 100 or to store relevant information there. For example, user profiles assigned to a particular air-conditioning system can be stored on the mobile terminal 70 and on the server 100.

Furthermore, the method according to the disclosure makes it possible to compare diagnostic information, which has been queried from the gateway device 60, with information from the server 100 and to carry out a self-diagnosis of the air-conditioning system on the basis thereof. Alternatively or additionally, appropriate diagnostic information can be previously stored on the server 100, with the result that said information can be queried and/or evaluated by a workshop.

In one exemplary embodiment of the disclosure, the mobile terminal 70 queries vehicle data and air-conditioning data, which relate to the heater 30, from the gateway device 60. In one exemplary embodiment, the vehicle data are an item of information which indicates the state of charge of the vehicle battery. The air-conditioning data indicate that the heater 30 is switched off. This information is displayed on the touchscreen 76 of the mobile terminal 70. According to the disclosure, the driver can actuate a button which states that the air-conditioning device, namely the heater 30, is intended to be started. The mobile terminal 70 processes this input and determines that, on account of a low state of charge of the battery, it is useful not to heat all available heating circuits provided in the vehicle. Instead, the intention is to use only the heating circuit which directly results in the heating of the passenger compartment. Accordingly, the mobile terminal 70 transmits a corresponding control command which is transmitted to the gateway device 60 via the Bluetooth module 74. The gateway device 60 in turn processes this control command and generates further control commands on the basis of the received control command. A first control command activates the heater 30. A second control command ensures circulation in said selected heating circuit which results in heating of the passenger compartment.

In one embodiment, profile data relating to the user which specify a particular flap position as the preferred flap position are stored on the mobile terminal 70. The mobile terminal can generate control commands in response to a user input and/or automatically when approaching the vehicle 1 and can transmit said control commands to the gateway device 60, which control commands cause the latter to transmit corresponding control commands for adjusting the flaps.

In one exemplary embodiment, the mobile terminal 70 makes it possible to query further information, for example the mileage of the vehicle 1, the outside temperature, the filling level of the tank and/or diagnostic information, via the gateway device 60 and to display said information to the user on the touchscreen 76. According to the disclosure, it is possible to use some or all of this information to control the air-conditioning system in a situation-dependent manner. The outside temperature can be used, for example, to select a power level for operating the heater 30. A corresponding selection can be made automatically and/or on the basis of a user input. According to the disclosure, it is conceivable to especially indicate at least one preferred power level for a particular outside temperature and/or a particular state of charge of the battery for the user.

In one exemplary embodiment, certain control commands or menu items can be hidden on the basis of the received vehicle data. For example, in the exemplary embodiment which has already been described and in which a particular heating circuit is selected, an operating element which usually allows the two heating circuits to be used can be hidden. In the case of a critical state of charge of the battery, a user element which usually makes it possible to start the heater 30 can likewise be hidden.

It is also possible to calculate a maximum running time of the heater 30 on the basis of the received information, for example the filling level of the tank and/or the state of charge of the battery. It is also conceivable to actively switch off the heater 30 via an appropriate control command on the basis of the calculated running time and/or shortly before reaching a critical state, with the result that the core functions of the vehicle 1 are not adversely affected.

The W bus 40 described can be replaced with any desired bus system, for example CAN or LIN, according to the disclosure.

The ventilation device 20 can communicate with the gateway device 60, for example via a bus system, instead of using a PWM signal or in addition to using the PWM signal. According to the disclosure, the plug-in LTE module 68 can be any desired plug-in communication module for communicating via ISM/WiFi, 2G/3G/4G or similar standards.

In at least one exemplary embodiment, a connection to the Internet via a cellular network, for example via LTE, is described. A corresponding connection to the Internet can also be established via a local area network.

It should be pointed out at this point that all of the parts described above are claimed as being essential to the disclosure alone and in any combination, in particular the details illustrated in the drawings. Modifications of these are familiar to a person skilled in the art. In particular, it is familiar to a person skilled in the art to combine the individual exemplary embodiments in any desired form.

### LIST OF REFERENCE SIGNS

1 Vehicle
2 Operating element
3 Fan flap
4 Internet
20 Ventilation device
21 Ventilation connection
30 Heater/auxiliary heating system
40 Air-conditioning bus, W bus
41, 41′, 41″ Connection for W bus
42 Vehicle bus, LIN bus
43, 43′ Connection for vehicle bus/LIN bus
55 Computing unit or microcontroller
60 Gateway device
61 Computing device/microcontroller
62 Bluetooth module
63, 63′ Bus communication device
65 Storage device
66 Temperature sensor
70 (Mobile) terminal
71 Computing device
72 Storage device
74 Bluetooth module
76 Touchscreen
75 UMTS module
80 Air-conditioning operating part
100 Server

1. Method for controlling at least one air-conditioning device of a vehicle, comprising the steps of:
querying first status data from a first bus which is connected to the at least one air-conditioning device, via a radio interface;
querying second status data from a second bus, which is connected to at least one actuator and/or sensor, via the radio interface;
displaying the first and second status data on a display;
receiving at least one user input;
processing the user input;
creating a control command on the basis of the user input and using at least one data element of the first and/or second status data;
transmitting the control command to the air-conditioning device via the radio interface.

2. Method according to claim 1,
wherein
a value is calculated on the basis of at least one data element of the first status data and at least one data element of the second status data and is displayed.

3. Method according to claim 1, wherein
at least some status data are indirectly queried via a gateway device.

4. Method according to claim 1, further comprising:
checking the availability of a number of communication channels to a/the gateway device of the vehicle;
selecting a communication channel on-the basis of the availability and a priority list, wherein the first and/or second status data are queried via the selected
communication channel.

5. Method according to claim 1, further comprising
reading a user profile from a storage device of a mobile terminal;
processing data from the user profile;
generating at least one control command on the basis of the data from the user profile;
transmitting the control command to the air-conditioning device and/or a component of the vehicle.

6. Method according to claim 1, further comprising:
querying and displaying a state of charge of a battery of a vehicle; and/or
querying and displaying a tank filling level of the vehicle.

7. Mobile terminal comprising:
at least one computing device;
at least one storage device containing instructions, wherein the instructions implement the method according to one of the preceding claims when they are executed on the at least one computing device;
at least one radio communication device for querying the first and/or second status data and/or for transmitting the control command.

8. System comprising:
a mobile terminal according to claim 7;
a gateway device which comprises at least one communication device, in particular a plug-in communication device, for wireless communication, wherein the communication device is designed to communicate with the mobile terminal.

9. System according to claim 8,
wherein
the gateway device comprises a first communication device for receiving first status data from the first bus and/or a second communication device for receiving second status data from the second bus.

10. System according to claim 8,
wherein
the gateway device comprises:
a/the first communication device for wirelessly communicating with the mobile terminal via Bluetooth and/or WiFi; and
a second communication device for communicating with the mobile terminal via a cellular network.

11. System according to claim 8,
wherein
the gateway device comprises:
at least one computing device;
at least one storage device containing instructions, wherein the instructions implement a web server when they are executed on the computing unit.

12. Computer-readable storage medium which contains instructions which cause at least one processor to implement a method according to claim 1 when the instructions are executed by the at least one processor.

13. System of claim 8, wherein the communication device is designed to communicate with the mobile terminal by Bluetooth communications.

14. System according to claim 10 wherein the first communication device is a/the plug-in communication device, and the a second communication device is a plug-in communication device.

15. System according to claim 14, wherein the second communication device is a GSM module or a UMTS module.

16. Method according to claim 1, wherein the first bus is an air-conditioning bus and the second bus is a vehicle bus.

17. Method according to claim 5, wherein transmitting the control command to the air-conditioning device and/or a component of the vehicle is performed using a/the gateway device.

18. System according to claim 9, wherein the first status data comprises air-conditioning data and the second status data comprises vehicle data.
